(19) United States
(12) Patent Application Publication
(10) Pub. No.: US 2014/0026648 A1
(43) Pub. Date: Jan. 30, 2014

(54) TIEFENBACH CONTROL SYSTEMS GMBH

(71) Applicants: Ulrich Schmitz, Dortmund (DE); Hans-Hermann Hunfeld, Mulheim (DE)

(72) Inventors: Ulrich Schmitz, Dortmund (DE); Hans-Hermann Hunfeld, Mulheim (DE)

(73) Assignee: TIEFENBACH CONTROL SYSTEMS GMBH, Bochum (DE)

(21) Appl. No.: 14/111,694

(22) PCT Filed: Mar. 28, 2012
(86) PCT No.: PCT/DE12/00324

§ 371 Date: Oct. 14, 2013

(30) Foreign Application Priority Data
Apr. 16, 2011 (DE) 10 2011 017 309.9

(51) Int. Cl. G05D 21/02

(52) U.S. Cl. CPC G05D 21/02
USPC 73/61.59

(57) ABSTRACT

A known metering system for automatically maintaining a predefinable concentration of a liquid corrosion inhibitor in the aqueous hydraulic liquid of a water-hydraulic hydraulic system is characterized in that the measuring circuit can be disconnected from the hydraulic system (controllable valves 14, 15), in that the measuring circuit can be short-circuited between the outlet line and the inlet line by means of controllable valves 16, 17 and can be connected to a source (cleaning tank 18) of a cleaning liquid for a cleaning circuit. As a result, a cleaning liquid for cleaning the concentration sensor can be circulated in the measuring circuit for a predefinable time. For the purpose of calibration, the metering system can be charged with a reference liquid with a known inhibitor concentration, in particular water, in particular water from the public supply. Further sensors (23-25) can be connected into the measuring circuit.

The invention relates to a metering system for corrosion inhibitors in a water-hydraulic hydraulic system for automatically maintaining a predefinable concentration of a liquid corrosion inhibitor in the aqueous hydraulic fluid according to the preamble of Claim 1.

This system is known, for example, from EP0062306A1.

However, said metering system suffers from the problem that the effectiveness thereof depends on the accuracy of the metering, and said metering, in turn, depends to a crucial extent on the accuracy of the measurement of the concentration of the corrosion inhibitor.

Therefore, it is the object of the present invention to improve the measurement accuracy, rendering it reliable to such an extent that any premature corrosion of valuable parts of the hydraulic system, which are susceptible to corrosion, is avoided, thereby realizing great savings with regard to the replacement of corroding parts, as well as a considerably improved safety.

The solution according to Claim 1 is characterized in that said solution only requires a minimum of extra complexity, and in that it is easily integrated in available configurations of such metering systems, as well as in existing systems.

The invention is based on the idea that inaccuracies of the measurement results involving concentration, of the corrosion inhibitor can only be established with any measure of reliability if the presence of the same measurement conditions is consistently ensured. This reestablishment of the original measurement conditions is achieved by a brief interruption of the metering operation. To this end, the metering system is disconnected from the hydraulic system by controllable valves and short-circuited by controllable valves to perform a cleaning circuit. The cleaning fluid is supplied to this cleaning circuit. If the cleaning fluid is water, particularly tap water, said water can be taken from the public utility supply network. Preferably, the cleaning fluid is stored inside a cleaning tank that is incorporated in the cleaning circuit. A metering pump further circulates the cleaning fluid within the cleaning circuit, and wherein the flow also moves around the concentration sensor for a predefinable amount of time, until cleaning and restoration of the original measurement conditions can be expected to have occurred.

Serving as a control as to whether the restoration of the original measurement conditions was successful is the configuration of the invention according to Claim 2. At this point, a fluid, a so-called reference fluid, is supplied to the measuring circuit, preferably while it is still short-circuited to the cleaning circuit. Afterwards, an inspection to determine as to whether the measurement result corresponds to the known concentration of the corrosion inhibitor can be implemented. In the easiest case scenario, the reference fluid can be water, particularly water from the public utility supply network. If deviations have occurred, the concentration sensor is recalibrated and adjusted to the known value.

An optical refractometer is conceivable for use as a concentration sensor.

The configuration according to Claim 4 also serves for monitoring the measurement conditions. This improvement is based on the finding that there exists a relationship of plausibility between different parameters of the hydraulic fluid and/or the cleaning fluid. This means that measured changes of the concentration of the corrosion inhibitor, for example, suggest that other parameters, such as, for example, ph, temperature, electric conductivity, must have changed as well. Therefore, such parameters are continuously measured during regular metering as well a measurement operations of the metering system. The plausibility adjustment can be achieved automatically by the memory and computing capacity of the metering system.

The improvement according to Claim 6 further promotes the effectiveness of the invention. It is provided therein that course impurities, such as foreign objects like stone and coal dust, chemical degradation and decomposition products, as well as organic materials and organisms, are removed from the tank, and thereby prevented from entering the measurement and cleaning circuits.

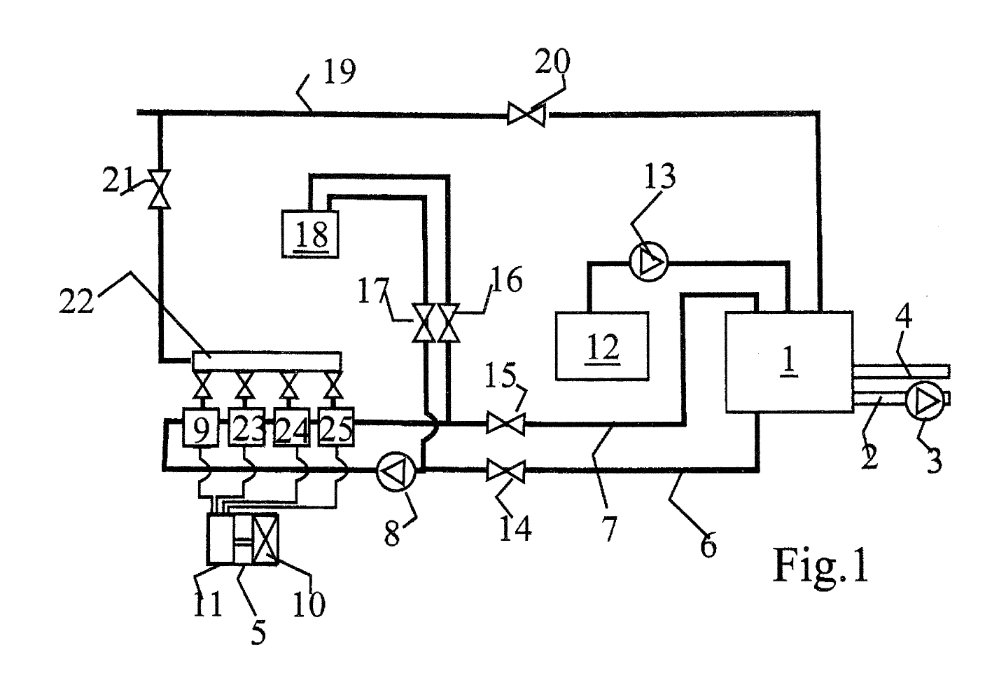

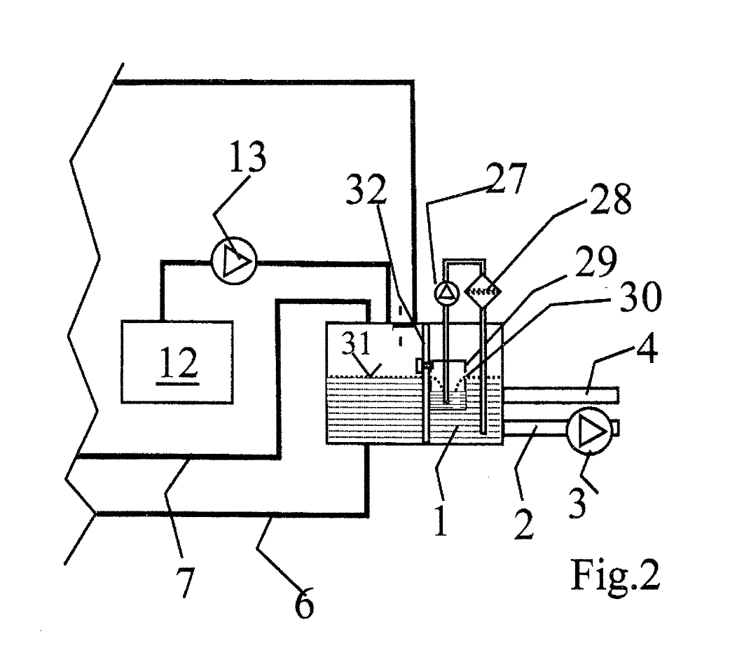

The improvement according to Claim 7 has special significance in that it allows for tracking the metering of the corrosion inhibitor. If system parts of the hydraulic system are damaged, this way, it can be established as to whether the damage occurred as a consequence of a defective system part or a defective metering operation. One embodiment will be described in detail below based on the drawing. FIGS. 1 and 2 are schematic views of a representation of the essential individual elements of the metering system.

Shown are the hydraulic tank 1, the pressure line 2 connected thereto with a pressure pump 3 and a return on line/tank line 4 leading to the tank of a hydraulic system of a mine operating underground. The hydraulic machines, particularly extraction supports with hydraulic cylinders and valves, etc. have been omitted.

The metering system includes a measuring circuit with sensors that are disposed therein. The measuring circuit is connected as a bypass in relation to the hydraulic system via an inlet line 6 and an outlet line 7 to the main tank 1. A continuously operating circulation pump 8 continuously circulates a partial volume within this metering circuit, and it is routed therein through the concentration sensor 9. The control means 5 has an electronic memory means 10, where the set value for the concentration of the corrosion inhibitor is saved. This set value is compared to the measured value of the concentration sensor 9 in the microprocessor 11, and a suitable output signal is then generated. In general, it is presently noted that the drawing does not show the control means of the metering pump and the valves, as well as the connections thereof, to the microprocessor to avoid compromising the clarity of the drawing. Said output signal activates a metering pump 13, and highly a concentrated corrosion inhibitor is removed from the reservoir of the corrosion inhibitor 12, then routed to the main tank 1, if the measured value of the concentration is below the set value. As soon as the measured value has returned the set value, the metering pump is deactivated. If, on the other hand, the measured value is above the set value, meaning the concentration of the corrosion inhibitor is too high, the microprocessor opens the water valve 20 in the water line 19. This supplies the main tank with fresh water to lower the concentration of the corrosion inhibitor until the set value is reached, at which point the water valve 20 is closed again.

The HFA (hydraulic fire-resistance anticorrosion) concentration in the hydraulic system is detected by means of an optical measurement method, a refractometer as concentration sensor 9. The control means 5 contains further sensors for detecting the actual values of parameters of the current state of the hydraulic fluid. These sensors are identified here by the reference numerals 23, 24, 25. The measured values of these sensors are also supplied to the microprocessor 11. The set values of the concentration of the corrosion inhibitor are stored and saved in the memory means 10 of the microprocessor 11 as a function of one or several of these parameters. By comparing the actual values of the concentration of the corrosion inhibitor, relative to the actual values of one or several of these parameters, the microprocessor 11 outputs a plausibility signal. As an alternate solution, the microprocessor 11 outputs the measured value, for example, as a temperature-compensated value. The control means 5 can also contain a monitor, presently not shown, where the measured values of the measured concentration of corrosion inhibitor and other parameter can be read. With a corresponding data transfer means, the monitor can also be located above ground.

This way, the metering system is able to control the HFA concentration of the hydraulic fluid automatically. If the HFA concentration is too low, the metering system controls the addition of concentrate via the current measured value. If the concentration is too high, the water valve 20 controls the dilution of the HFA fluid to the adjusted set value. If the concentration is too low, the metering pump 13 controls the addition of the concentrate to the main tank. Integrated level indicators (omitted) show the filling level in the main tank, the concentrate tank 12 and the cleaning tank 18.

Individually adjustable warning and alarm values visualize deviations from the set values. All measured values are saved in the documentation mode of the system. This way, it is always possible to ascertain as to whether damage to system parts of the hydraulic system has occurred due to defective parts or defective metering.

According to the invention, the metering system also includes means for cleaning the sensor mechanism. Cleaning occurs in a separate cleaning circuit that is activated automatically at regular intervals or when needed, when, for example, the measured values of the concentration and the other parameters are no longer plausible.

The cleaning circuit is created by disconnecting the measuring circuit from the hydraulic system by closuring the valves 14,15 in the inlet line 6 and outlet line 7, and in that, instead, the cleaning tank 18 is switched to the circuit by opening the cleaning valves 16,17.

Thus, when closing this cleaning circuit, the measuring circuit is interrupted and the circulation pump 8 pumps the content of the cleaning tank via the sensors into the cycle. The cleaning agent is made of water or an emulsion plus any additives that are expedient.

The second solenoid valve 21 is provided for the zero-point control. This valve is triggered to open according to the requirements, automatically or manually, during the metering or cleaning operation. A water distributor 22 therein serves to supply to the individual sensors, particularly the concentration sensor, ph sensor 23, temperature sensor 24, conducting capacity sensor 25, depending on where a zero-point control seems necessary. Alternately, it is possible to supply a fluid with a known corrosion inhibitor concentration, for example via the cleaning tank or a separate connection.

By regular cleaning and zero-point control, reproducible and comparable measuring results are made available at all times and over long periods of time,

which allow for making statements at to the state of the system.

FIG. 2 shows a detail of the system according to FIG. 1. The hydraulic tank 1 is visible with the tank line 4, the pressure line 2 and the pressure pump 3, as well as parts of the measuring circuit with inlet line 6, outlet line 7, concentrate tank 12 and metering pump 13. The second cleaning circuit 26 is depicted as well. Said cleaning circuit takes hydraulic fluid from tank 1 by means of pump 27 and circulates this flow through the cleaning filter 28. Experience has shown that impurities collect primarily on the surface 31 inside tank 1. These impurities can be dust, particularly coal and stone dust. However, they can also be organisms as well as degradation and decomposition products that form in the hydraulic fluid, floating primarily on the surface. A special removal means 29, such as a skimmer, is provided to capture these impurities. A height-adjustment means 32 is able to adjust the removal means 29 to the desired filling level of the tank, such that the inlet openings 30 of the removal means 29 are always located on the surface of the fluid 31. The removal means 29 can, by way of an alternate solution, also float on the fluid, guided straight. This way, the removal means is able to automatically adjust itself to the changing filling level of the tank 1. Said device 29 allows for removing coarse impurities that cause the irreversible fouling of the sensors by keeping them away from the measurement and cleaning circuits.

### LIST OF REFERENCE NUMBERS

1. Hydraulic tank 1

2. Pressure line 2

3. Pressure pump 3

4. Tank line 4

5. Control means 5

6. Inlet line 6

7. Outlet line 7

8. Circulation pump 8

9. Concentration sensor 9

10. Memory means 10

11. Microprocessor 11

12. Reservoir of the corrosion inhibitor 12; concentrate tank 12

13. Metering pump 13; concentrate pump 13

14. Controllable valves 14,15

15. Controllable valves 14,15

16. Controllable valves 16,17; cleaning valves 16,17

17. Controllable valves 16,17; cleaning valves 16,17

18. Source-cleaning tank 18

19. Water line 19

20. Water valve 20

21. Solenoid valve (4) for zero-point control

22. Water distributor 22

23. ph sensor

24. Temperature sensor

25. Conducting capacity sensor

26. Second cleaning circuit

27. Cleaning pumpe 27

28. Cleaning filter 28

29. Removal means; skimmer 29

30. Inflow openings

31. Surface 31

32. Height-adjustment means 32

1.-7. (canceled)

8. A metering system for automatically maintaining a predefinable concentration of a fluid corrosion inhibitor in an aqueous hydraulic fluid of a water-hydraulic system that is supplied via a pressure line, a pressure pump and a tank line from a hydraulic tank, wherein the metering system includes:
a measuring circuit that is connected as a bypass to the hydraulic system via an inlet line, on the one hand, and via an outlet line, on the other hand,
a circulation pump that is switched to the measuring circuit for the continuous removal of a partial volume of hydraulic fluid from the hydraulic system,
a concentration sensor that is immersed in the measuring circuit for the continuous concentration measurement of the corrosion inhibitor in the partial volume that was removed from the hydraulic system,
a control means with a memory means for saving the pre-definable concentration of the corrosion inhibitor and a microprocessor for generating a difference signal from the value of the saved, predefinable concentration of the corrosion inhibitor and the current concentration of the corrosion inhibitor detected by the concentration sensor,
a reservoir of the corrosion inhibitor for the corrosion inhibitor agent, and
a metering pump that is connected, on the one hand, to the reservoir of the corrosion inhibitor and, on the other hand, to the hydraulic system, and that can be controlled as a function of the difference signal of the control means such that the hydraulic fluid is enriched with the corrosion inhibitor agent to such a level as a predefined concentration of the corrosion inhibitor and such that the concentration does not drop below the predefinable concentration of the corrosion inhibitor,
wherein the measuring circuit can be disconnected from the hydraulic system, the outlet line and the inlet line can be short-circuited, and a connection can be created to a source of a cleaning fluid to establish a cleaning circuit recirculating, for a predefined amount of time, a cleaning fluid for cleaning the concentration sensors in the measuring circuit.

9. The metering system according to claim 8, wherein water is used as cleaning fluid, particularly tap water taken from a public utility supply network.

10. The metering system according to claim 8, wherein a reference fluid having a known corrosion inhibitor concentration, particularly water, particularly water taken from a public utility supply network, can be supplied to the measuring circuit, and in that the measured value of the concentration sensor is adjusted with the known value of the corrosion inhibitor concentration.

11. The metering system according to claim 8, wherein the concentration sensor is an optical refractometer.

12. The metering system according to claim 8, wherein further sensors are switched to the measuring circuit for measuring the properties of the hydraulic fluid and/or of the cleaning fluid, particularly for measuring the ph, the temperature, the electric conducting value.

13. The metering system according to claim 8, wherein, parallel to the measuring circuit, a second cleaning circuit with a tank is connected via an inlet line and an outlet line, also connected is a circulation pump, that is switched to the cleaning circuit, and a cleaning filter, wherein the inlet line is preferably connected to the tank via a height-adjustable skimmer.

14. The metering system according to claim 8, wherein the control means contains a long-term memory for saving the measured values that are captured during the metering cycles, and preferably also during the cleaning circuits.
